(19) United States
(12) Patent Application Publication
(10) Pub. No.: US 2007/0064668 A1
(43) Pub. Date: Mar. 22, 2007

(54) Method and apparatus for improving transmission delay of status report in a wireless communications system

(75) Inventor: Sam Shiaw-Shiang Jiang, Taipei City (TW)

Correspondence Address: BIRCH, STEWART, KOLASCH & BIRCH, LLP, 8110 GATEHOUSE ROAD, SUITE 100 EAST, FALLS CHURCH, VA, 22315, US

(73) Assignee: ASUSTeK COMPUTER INC.

(21) Appl. No.: 11/522,992

(22) Filed: Sep. 19, 2006

Related U.S. Application Data
(60) Provisional application No. 60/596,401, filed on Sep. 21, 2005.

(51) Int. Cl. H04J 3/16

(52) U.S. Cl. 370/346

(57) ABSTRACT

A method for improving transmission delay of a status report in a wireless communications system operating in an Acknowledged Mode includes triggering a status report transfer procedure and transmitting a status report packet a predetermined number of times that is more than one. A related wireless communications apparatus has a control circuit, a central processing unit, a memory, and program code for triggering a status report transfer procedure and transmitting a status report packet a predetermined number of times that is more than one.

### CROSS REFERENCE TO RELATED APPLICATIONS

This application claims the benefit of U.S. Provisional Application No. 60/596,401, filed on Sep. 21, 2005 and entitled “METHOD AND APPARATUS TO IMPROVE TRANSMISSION DELAY OF SIGNALING MESSAGES,” the contents of which are incorporated herein by reference.

### BACKGROUND OF THE INVENTION

1. Field of the Invention

The present invention relates to Acknowledged Mode (AM) wireless transmissions in mobile communications systems, and more particularly, to a method and related apparatus for reducing transmission delay in a wireless communications device operating in AM by transmitting a status report a predetermined number of times greater than 1.

2. Description of the Prior Art

With an arrival of an Information Age, demand for mobile voice and data communications and all kinds of mobile services increases daily. A prior art mobile communications system is already confronted with bottlenecks of insufficient frequency channels utilization and insufficient transmission speeds. Thus, third generation (3G) mobile communications technologies that provide higher frequency spectrum utilization and services with higher transmission speeds are already arriving on the scene. Compared to technologies of a second generation (2G) mobile communications system, a most fundamental differentiator in the 3G mobile communications system is adoption of a wideband code division multiple access (WCDMA) method, which is used to provide high-frequency spectrum utilization, universal coverage, and high quality, high speed multimedia data transmission. The WCDMA method also meets all kinds of QoS requirements simultaneously, providing diverse flexible two-way transmission services and better communication quality to reduce transmission interruption rates.

Taking a wireless communications protocol standard set forth by the 3^{rd} Generation Partnership Project (3GPP) as an example, the 3G mobile communications system can provide different levels of transmission quality, and can operate in different modes based on different transmission quality requirements, e.g. Transparent Mode (TM), Unacknowledged Mode (UM), and Acknowledged Mode (AM). TM is appropriate for use in services with high requirements for real-time transmission, UM is appropriate for use in services with requirements for real-time transmission and packet sequencing, and AM is appropriate for use in services with low requirements for real-time transmission, but high requirements for data accuracy.

In AM, in order to provide high data accuracy, a Radio Link Control (RLC) layer protocol comprises an Automatic Retransmission Request (ARQ) process. A transmitter can accordingly trigger a polling function to determine a data transmission status. When a receiver receives a polling request, the receiver triggers a status report function to respond to the transmitter with the data reception status. When the transmitter desires to poll the receiver, the transmitter sets a polling bit of a Protocol Data Unit (PDU) to a preset value (such as “1”). When the receiver receives the PDU, i.e. when the receiver receives the polling request, the receiver uses a status report or a piggybacked status report to respond to the transmitter with the data reception status. In this way, the transmitter can execute follow-up processes, such as advancing a transmission window or retransmitting PDUs, based on the status report sent by the receiver. In the transmitter, the polling function can be triggered in any of the following ways:
1. Last New PDU—When a PDU is a last new PDU available for transmission by the transmitter, the polling process is triggered, i.e. the polling bit of the PDU is set to the preset value.
2. Last Retransmitted PDU—When a PDU is a last retransmitted PDU, the polling process is triggered.
3. Timer_Poll—Trigger a polling timer (Timer_Poll) after a poll has been sent. When Timer_Poll expires, trigger a new polling process to perform polling.
4. Every Fixed Number of PDUs—After each time a fixed number of PDUs (including retransmitted PDUs and new PDUs) have been transmitted, trigger a polling process.
5. Every Fixed Number of SDUs—After each time a fixed number of Service Data Units (SDU) have been transmitted, trigger a polling process.
6. Window based—Trigger a polling process based on a transmission percentage of a transmission window.
7. Timer based—Trigger a polling process periodically.

Thus, based on different transmission requirements, the system can use the different methods described above to trigger the polling function at an appropriate time to request that the receiver responds with a status report, thereby determining the data transmission status. The receiver triggers a status report transfer procedure to send a status report when receiving the polling request described above. Additionally, when the receiver detects one or multiple missing PDUs, the receiver can actively transmit a status report to the transmitter, so as to remind the transmitter to retransmit the missing PDUs. Furthermore, the receiver can output a status report periodically to the transmitter to report the data transmission status. Thus, after the transmitter receives the status report sent from the receiver, the transmitter can determine the data transmission status to execute the follow-up processes.

Use of the ARQ process (the polling and status report process) improves the accuracy of the data transmission and utilizes radio resource efficiently. However, the ARQ process is time consuming. Upper layer signaling messages need to be transmitted accurately. AM transmission mode with ARQ process can fulfill the accuracy requirement. However, because of the nature of radio interference, the polling PDU and the status report may get lost during radio transmission. This will affect the transmission throughput of upper layer signaling messages. As an example, the call setup time may be delayed due to radio interference. The effect of radio interference to the ARQ process is further analyzed below.

When the receiver receives the polling request, the receiver outputs a status report to the transmitter to prompt the transmitter to retransmit missing PDUs. At this time, if interference or an error occurs during radio transmission of the status report, the transmitter must wait for the timer Timer-poll to expire before it can retransmit the polling request. The receiver only outputs the status report again after receiving the retransmitted polling request. Please refer to FIG. 1. As shown in FIG. 1, the transmitter outputs PDUs 300, 302, 304 with respective sequence numbers (SN) 11, 12, 13 to carry an SDU (not shown), wherein a polling bit P of the PDU 304 is set to a value of “1.” Suppose that radio interference occurs when transmitting the PDU 302 so that the receiver does not successfully receive the PDU 302. After the receiver receives a polling request contained in the PDU 304, the receiver responds with a status report 306 to prompt the transmitter to retransmit the PDU 302. At this time, if the status report 306 gets lost over the air due to radio interference so that the transmitter is unable to receive the status report 306, the transmitter has no way of knowing that the receiver has not yet received the PDU 302. When the timer Timer_poll eventually expires, the transmitter will determine the transmission error, retransmit the PDU 304a with SN=13 and set the polling bit to 1. After the receiver receives the PDU 304a that was retransmitted, because the receiver still has yet to receive the PDU 302 with SN=12, the receiver will send another status report 306a to the transmitter to prompt the transmitter to retransmit the PDU 302. Then, based on the status report 306a, the transmitter will retransmit a PDU 302a with SN=12, and set the polling bit of the PDU 302a to a value of “1.” In other words, when the receiver detects the polling request, the receiver will output the status report to the transmitter. If an error or radio interference occurs during transmission of the status report, although the prior art is able to detect the error, the prior art is unable to prevent the error. Thus, the throughput of upper layer signaling messages may be deteriorated. As a result, the utilization comfort of the ender users is affected due to ARQ process and radio interference.

Simply speaking, through use of the ARQ process, the prior art can guarantee data accuracy. However, if an error occurs in the transmission of related PDUs or the status report, a transmission delay is caused, which affects transmission throughput and comfort of end users.

### SUMMARY OF THE INVENTION

According to the claimed invention, a method of improving transmission delay of a status report in a wireless communications system operating in Acknowledged Mode comprises triggering a status report transfer procedure and transmitting the status report a predetermined number of times that is greater than 1.

According to the claimed invention, a wireless communications apparatus operating in Acknowledged Mode utilized in a wireless communications system for improving transmission delay of a status report comprises a control circuit for realizing functions of the wireless communications apparatus, a central processing unit for executing program code to control the control circuit, and a memory for storing the program code. The program code comprises triggering a status report transfer procedure and transmitting the status report a predetermined number of times that is greater than 1.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a status report transmission error in a mobile communications system according to the prior art.

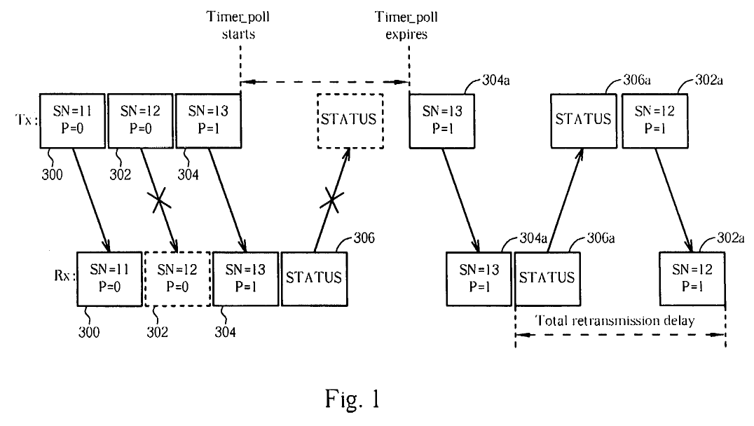

FIG. 2 is a functional block diagram of a mobile communications device according to the present invention.

FIG. 3 is a diagram of a program code of FIG. 2.

FIG. 4 is a flow chart of a process according to the present invention.

FIG. 5 is a diagram of a realization of the process of FIG. 4.

### DETAILED DESCRIPTION

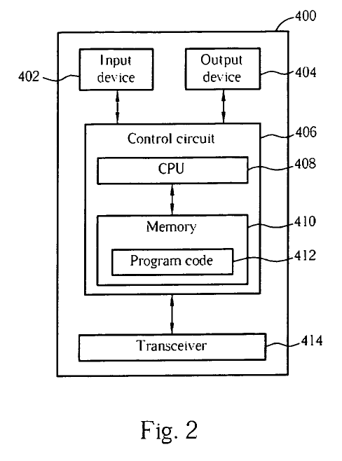

Please refer to FIG. 2. FIG. 2 is a functional block diagram of a wireless communications device 400 according to the present invention. For simplicity, FIG. 2 only shows an input device 402, an output device 404, a control circuit 406, a central processing unit (CPU) 408, a memory 410, program code 412, and a transceiver 414 of the wireless communications device 400. In the wireless communications device 400, the control circuit 406 executes the program code 412 in the memory 410 through the CPU 408, thereby controlling an operation of the wireless communications device 400. The wireless communications device 400 can receive signals input by a user through the input device 402, such as a keyboard, and can output images and sounds through the output device 404, such as a monitor or a speaker. The transceiver 414 is used to receive and transmit wireless signals, transmitting received signals to the control circuit 406, and outputting signals generated by the control circuit 406 wirelessly. From a perspective of a communications protocol framework, the transceiver 414 can be seen as a portion of Layer 1, and the control circuit 406 can be utilized to realize functions of Layer 2 and Layer 3.

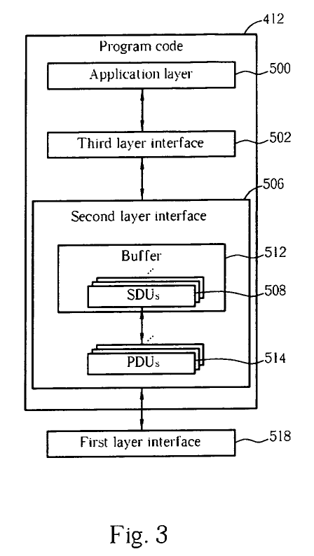

Please continue to refer to FIG. 3. FIG. 3 is a diagram of the program code 412 shown in FIG. 2. The program code 412 comprises an application layer 500, a Layer 3 interface 502, and a Layer 2 interface 506, and is coupled to a Layer 1 interface 518. When a signal is transmitted, the Layer 2 interface 506 forms a plurality of SDUs 508 according to data outputted by Layer 3 interface 502, and stores the plurality of SDUs 508 in a buffer 512. Then, according to the SDUs 508 stored in the buffer 512, the Layer 2 interface 506 generates a plurality of PDUs 514, and sends the plurality of PDUs 514 to a destination terminal through the Layer 1 interface 518. In contrast, when a wireless signal is received, the signal is received through the Layer 1 interface 518, then outputted as PDUs 514 to the Layer 2 interface 506. The Layer 2 interface 506 restores the PDUs 514 to SDUs 508 and stores the SDUs 508 in the buffer 512. Last, the Layer 2 interface 506 transmits the SDUs 508 stored in the buffer 512 to the Layer 3 interface 502.

The wireless communications device 400 is preferably used in a 3G mobile communications system. When the wireless communications device 400 is operated in AM, to reduce the transmission delay of the prior art, the present invention utilizes a following process to set a related algorithm in the program code 412 to resolve the problems of the prior art.

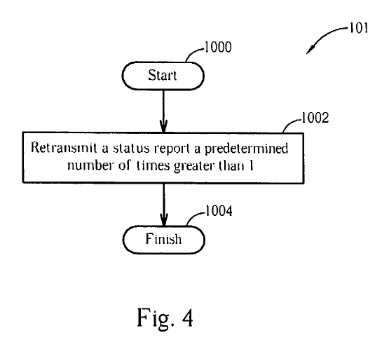

Please refer to FIG. 4. FIG. 4 is a flow chart of a process 101 according to the present invention. The process 101 comprises steps of:

Step 1000: Start.

Step 1002: Trigger a status report transfer procedure.

Step 1004: Retransmit a status report a predetermined number of times that is greater than 1.

Step 1006: End.

Thus, according to process 101, when the receiver is triggered to transmit a status report, the receiver transmits the status report more than once to guarantee that the status report is received successfully by the transmitter. In other words, the process 101 increases a probability that the status report will be transmitted accurately to the transmitter by retransmitting the status report, thereby reducing transmission delay.

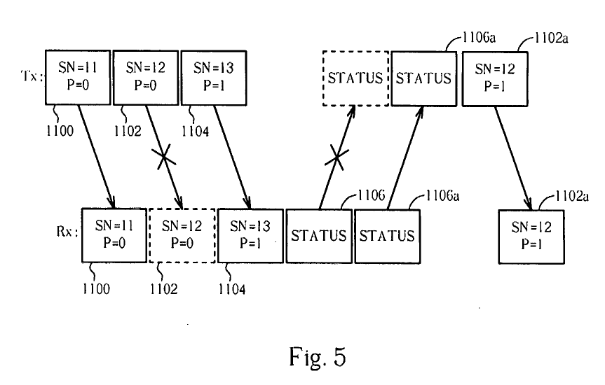

For example, in FIG. 5, the transmitter outputs PDUs 1100, 1102, 1104 with respective SNs 11, 12, 13 to carry an SDU (not shown), and the polling bit of the PDU 1104 has a value of “1.” Suppose that radio interference occurs when transmitting the PDU 1102 so that the receiver is unable to successfully receive the PDU 1102. When the receiver receives the polling request contained in the PDU 1104, the receiver will transmit the status report 1106, 1106a twice, in order to prompt the transmitter to retransmit the PDU 1102 that was not received. At this time, if the status report 1106 gets lost over the air due to radio interference, the transmitter can still receive the status report 1106a, thereby determining that the receiver did not receive the PDU 1102 with SN=12. Thus, the transmitter will retransmit the PDU 1102a with SN=12. Generally, the polling bit of the PDU 1102a is set to a value of “1,” but how the polling bit is set in the PDU 1102a is not directly related to the present invention, and is not a necessary characteristic of the present invention. In other words, according to the process 101, if the receiver is triggered to transmit a status report, e.g., detecting a missing PDU, the receiver will repeatedly transmit the status report to the transmitter to prompt the transmitter to retransmit the missing PDU. Because the present invention repeatedly transmits the status report, the present invention can prevent one cause of delay that arises due to radio interference, thereby increasing ease of use.

Summing up the above description, the present invention improves the probability of success in the status report transfer procedure by repeatedly transmitting the status report, thereby reducing transmission delay and improving ease of use.

Those skilled in the art will readily observe that numerous modifications and alterations of the device and method may be made while retaining the teachings of the invention. Accordingly, the above disclosure should be construed as limited only by the metes and bounds of the appended claims.

1. A method of improving transmission delay of a status report in a wireless communications system operating in Acknowledged Mode comprising:
triggering a status report transfer procedure;
transmitting the status report a predetermined number of times that is greater than 1.

2. A wireless communications apparatus comprising a central processing unit in electrical communications with a memory, the memory comprising program code for implementing the method of claim 1.

3. (canceled)

4. (canceled)

5. The method of claim 1 with a wireless communications apparatus having a central processing unit in electrical communications with a memory, the memory comprising program code for implementing the method of claim 1, wherein predetermined number of times in the transmitting step is 2 times.

6. The method of claim 1 and a wireless communications apparatus having a central processing unit in electrical communications with a memory, the memory comprising program code for implementing the method of claim 1, wherein the status report of the triggering step is a piggybacked status report.
